(19) United States
(12) Patent Application Publication
(10) Pub. No.: US 2014/0313710 A1
(43) Pub. Date: Oct. 23, 2014

(54) Lighting Structure and System

(71) Applicant: Elmer A. Wessel, Lincoln, NE (US)

(72) Inventor: Elmer A. Wessel, Lincoln, NE (US)

(21) Appl. No.: 14/174,687

(22) Filed: Feb. 6, 2014

Related U.S. Application Data
(60) Provisional application No. 61/761,544, filed on Feb. 6, 2013.

(51) Int. Cl. F21S 4/00

(52) U.S. Cl. CPC F21S 4/003; F21Y 2101/02
USPC 362/217.14

(57) ABSTRACT

A lighting structure and system, particularly for merchandizers, is disclosed. The structure is a lighting strip with a housing pedestal, embedded lights, which are preferred to be LED's, and a connection strip which interfaces with the C-bracket (which is usually used to hold pricing and product information) of most merchandizers. The structure may be adapted to be integrated into a larger lighting paradigm for merchandizers, including electronic and computer control.

### CROSS-REFERENCE TO RELATED APPLICATION

This application claims priority as a non-provisional perfection of prior filed U.S. provisional application No. 61/761,544, filed Feb. 6, 2013, and incorporates the same by reference in its entirety herein.

### FIELD OF THE INVENTION

The present invention relates to the field of lighting and more particularly relates to a light strip that may be affixed to current merchandising racks.

### BACKGROUND OF THE INVENTION

Merchandizing is an aid to the foundation of our free market system. The free market is driven by supply and demand and merchandizing helps stimulate demand for a displayed product by making it more attractive to the potential customer. As a result merchandizing displays, or “merchandizers,” are designed to not only hold product for sale and allow consumers to see and inspect the product, but also to attract a customer's attention, showcase the product in a positive light and create the desire to buy the product. Many studies have been made into consumer psychology and one common understanding is that a well-lit display can be useful in drawing the consumer's attention and stimulating the purchase impulse.

However, lighting can be difficult to install in current merchandisers. Not only does such installation often alter the merchandiser, it also requires precision and skill to focus lights in the right manner. Sometimes altered merchandisers must then be dedicated to the products for which they have been modified.

The present invention is a lighting fixture that fits on a common structure of most merchandizing racks. It is useful for most products, including but not limited to the “impulse” products and magazines usually displayed at checkout counters as well as any product that is suited to be displayed on a shelf-type rack.

The present invention represents a departure from the prior art in that the lighting structure of the present invention allows for quick and easy installation of cost effective LED lighting in a manner that accommodates most merchandisers while maintaining a finished look and presenting an appealing lighting solution for lighting product. The lighting structure of the present invention is also well suited to individual lighting controls, such as by motion sensor or remote control by a microprocessor.

### SUMMARY OF THE INVENTION

In view of the foregoing disadvantages inherent in the known types of merchandizer lighting systems, this invention provides an easily integrated and adaptable lighting structure and system. As such, the present invention's general purpose is to provide a new and improved lighting structure that is configured to interface with merchandizer racks in the “C” bracket where pricing information is usually located and light sources which are angled to direct light onto merchandized product.

To accomplish these objectives, the lighting structure comprises an elongate lighting housing with inner and outer sides. The inner side features an elongate tab which slides into the “C” bracket of most merchandizers. At least one strip of lights, preferably low power consumption LED lights, which are positioned in a trough towards the back of the structure and are angled to project light onto either an upper or a lower merchandise storage area in the merchandizer.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of an embodiment of described lighting structure installed on a typical merchandiser shelf

FIG. 2 is a side elevation of the lighting structure and shelf of FIG. 1.

FIG. 3 is a close-up view of the lighting structure and shelf taken in Circle A of FIG. 2.

FIG. 4 is a perspective view of a the embodiment shown in FIG. 1, removed from the shelf.

FIG. 5 is a front perspective view of the lighting structure of FIG. 1

FIG. 6 is a front plan view of the lighting structure of FIG. 1.

FIG. 7 is a sectional view of the lighting structure of FIG. 6, taken along line C-C.

FIG. 8 is a rear perspective view of the lighting structure of FIG. 1.

FIG. 9 is a close-up view of the lighting structure of FIG. 8, taken in circle B.

FIG. 10 is a perspective view of three lighting structures mounted upon a three-tiered magazine rack.

FIG. 11 is a side elevation of the magazine rack of FIG. 10, detailing the direction of light beams emanating from the light strips.

### DETAILED DESCRIPTION OF THE PREFERRED EMBODIMENT

With reference now to the drawings, the preferred embodiment of the lighting structure and system is herein described. It should be noted that the articles “a”, “an”, and “the”, as used in this specification, include plural referents unless the content clearly dictates otherwise.

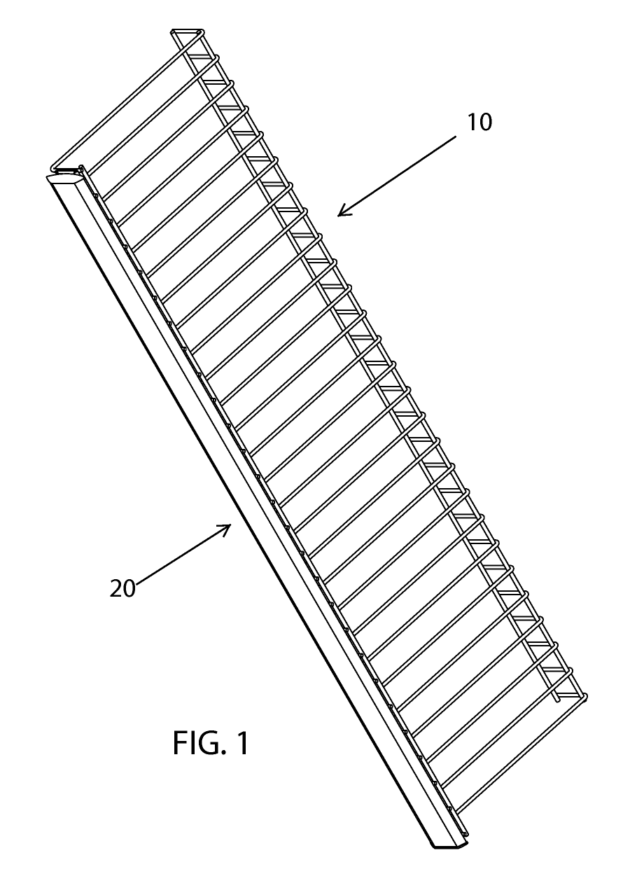

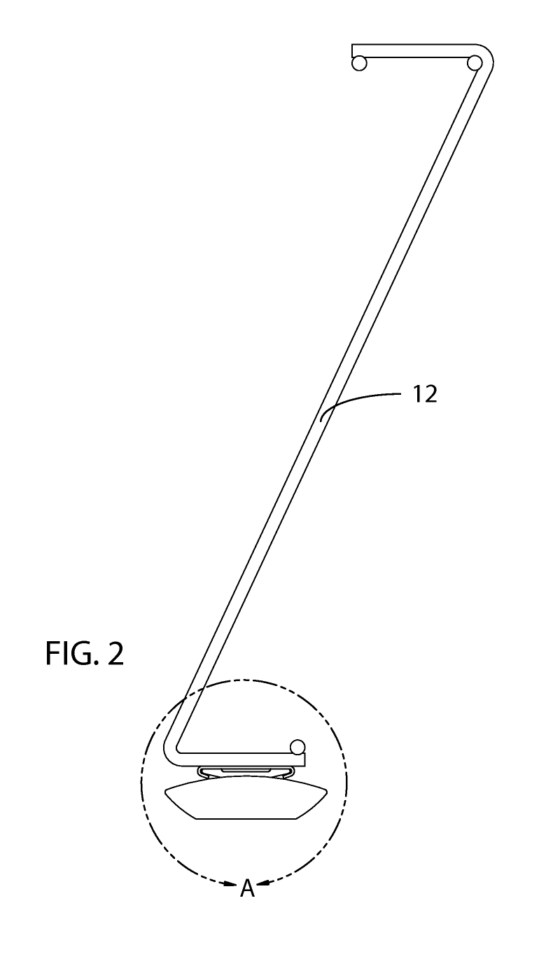

With reference to FIGS. 1-4, a lighting structure 20 is installed upon a merchandizer shelf or rack 10. Upon closer inspection, shown in FIGS. 2-4, it is shown that this particular embodiment of the lighting structure 20 has a strip-like pedestal trunk serving as a light housing (best seen in FIG. 7) with an elongate tab or blade 24 on its hind side. The pedestal trunk 22 is topped with a flared crown 27, featuring a front face 28 (on which pricing information may be placed) and a plurality of side faces 26, into which product information labels may be placed. Base 24 is ideally an elongate blade which extends to either side of the trunk 22. The crown 27, trunk 22 and base 24 of the pedestal are arranged to form, ideally, two channels or troughs 25 just underneath the side faces.

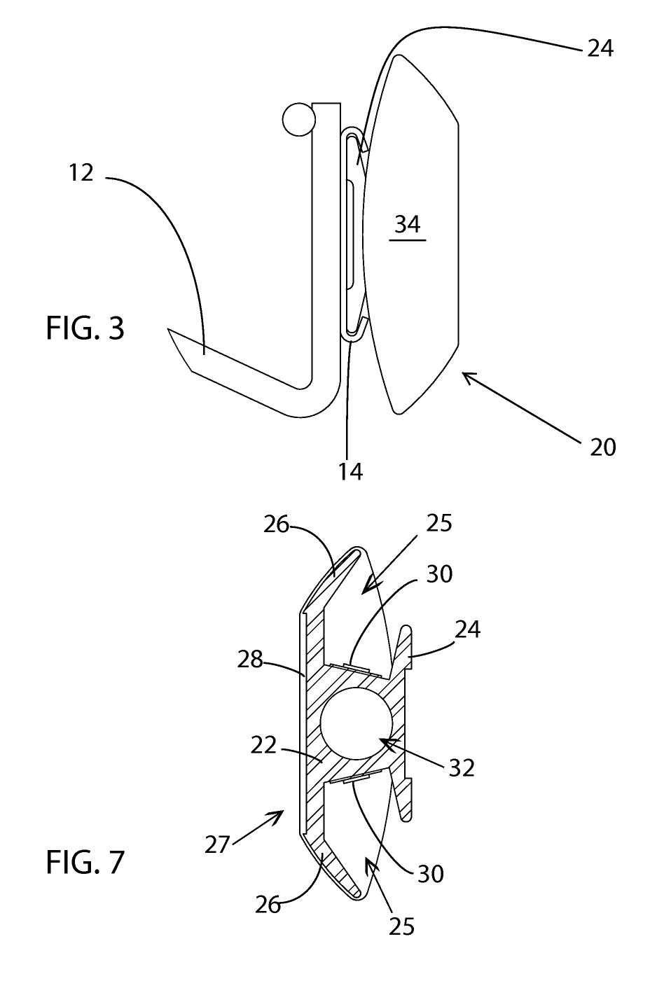

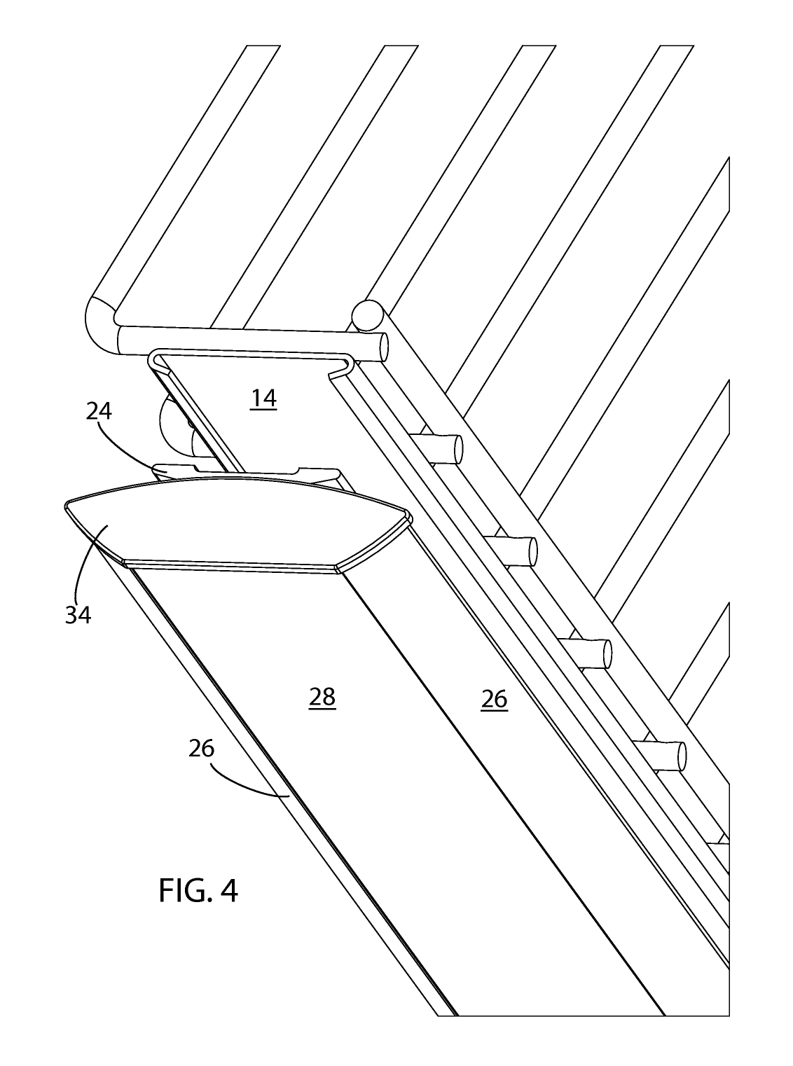

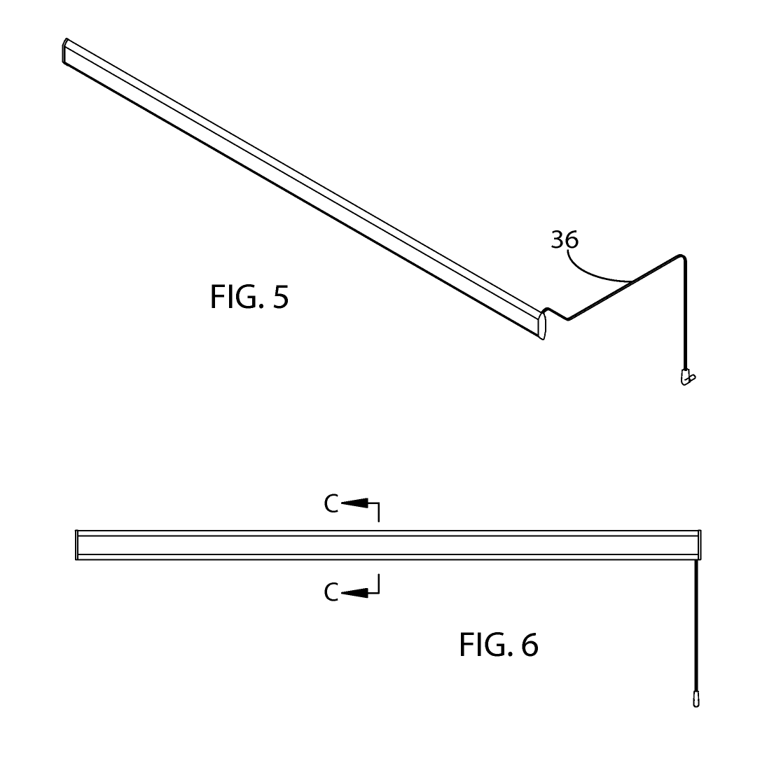

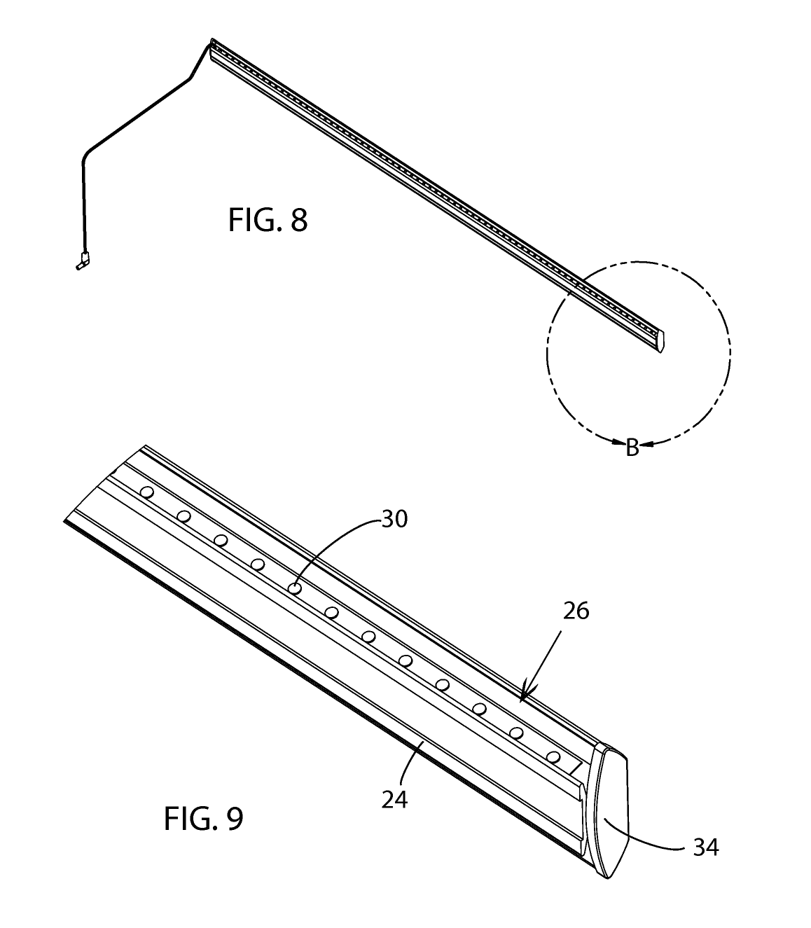

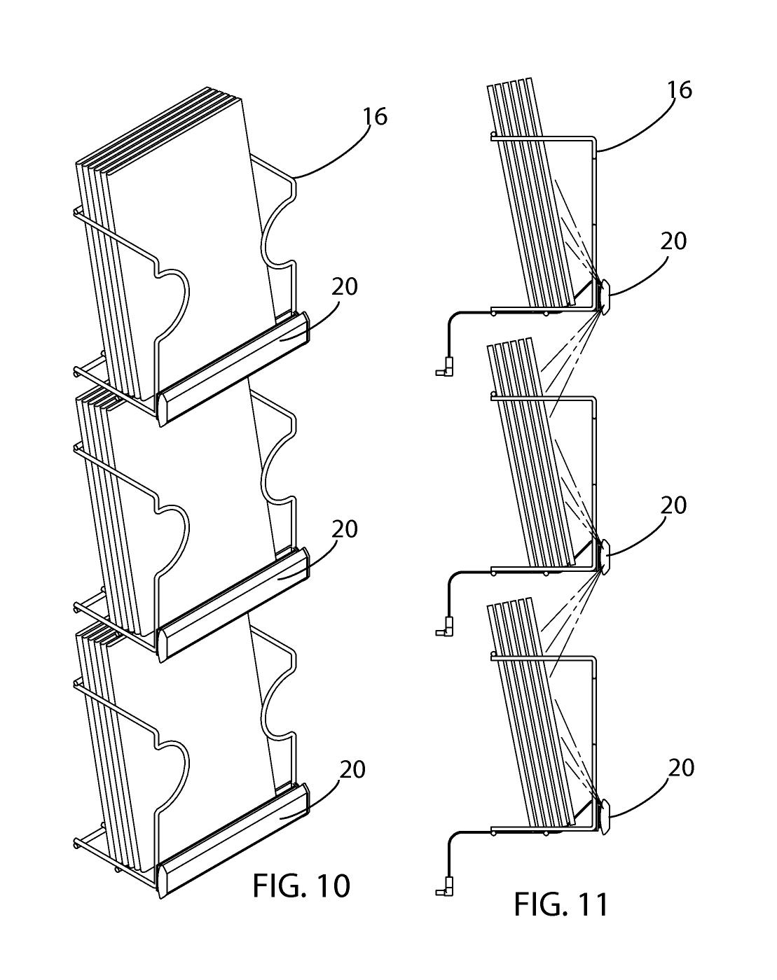

In order to illuminate product, lights are installed in troughs 25 underneath and behind the side faces (FIGS. 7 and 9). Troughs 25 are shaped and positioned so that a light source, like LED strip 30, may be positioned within a trough 25. The walls of the troughs 25 are prismatic, acting as facets, and will direct and shine light onto product held on the merchandizer, like magazine rack 16 (FIGS. 10 and 11)—ideally, rearwards and either above or below the lighting structure 20. The facets may also be highly polished or may have a highly reflective surface applied to them in order to enhance reflection. Ideally, a strip of LED's 30 would be used as the light source as they are cost effective to manufacture, have a low energy cost, produce little heat and can be efficiently installed within a trough 25. Other lighting solutions may be used so long as the light source fits within the trough 25 and body 22. The troughs 25 may be positioned and angled in any manner to allow a light source 30 to illuminate racks behind and above or below the lighting structure 20, or to accommodate and direct any other desired light source. Accordingly, ideal angle values of the resultant shape will be dependent upon intended light source, shape of the lighting assembly 20 and desired effect, but are easily determined once those desired values are known. End caps 34 (FIGS. 3 and 4) may be provided on the trunk 22 to provide a finished look. To this end, other useful features, such as motion and proximity detectors, may also be installed on or around the lighting structure 20, and such detectors and the lighting may be operatively connected to and controlled by a microprocessor to create attention garnering effects and control the display environment.

The merchandizer rack 10 (FIGS. 1-4) is simply shown to be a plurality of rods 12 with a C-bracket 14 and other lateral supports, but the lighting structure 20 may be utilized in any merchandizer that features a similar C-bracket 14, like the magazine merchandizer of FIGS. 10 and 11. To install the lighting structure 20, the blade 24 is simply slid into the C-bracket 14 and cords 36 are directed to a power or control source. It should be noted that the bottom lighting structure 20, as shown in FIGS. 10 and 11, does not feature a bottom light. There may also be situations where a top light is not necessary. Either construction may be effected by merely not placing any lighting units 30 in the bottom or top trough 25 or by eliminating the creation of one trough 25 entirely. It should be noted that, for the preferred embodiment, the terms “top” and “bottom” are referenced in relation to the merchandizer shelf on which the lighting structure is mounted as the preferred embodiment is symmetrical. It is also conceivable that the lighting structure 20 may be mounted on top of the merchandizer, with both troughs 25 facing downward, in which case “top” and “bottom” would be “left” and “right.” The ultimate shape and size of the lighting structure 20 is determined by the desired lighting effect and the merchandizer for which the lighting structure is intended and that ultimate design does not have to be symmetrical.

The preferred embodiment will be manufactured from lightweight yet durable materials, such as aluminum and/or plastic, which are economical to manufacture while maintaining acceptable durability. The material may be extruded with a bore 32 centrally located within the trunk 22 to decrease mass and facilitate the manufacturing process.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A lighting structure comprising:
a. an elongate pedestal, the pedestal further comprising;
i. a base extending along a length of the pedestal;
ii. a trunk extending approximately perpendicularly from the base;
iii. a crown extending outward from a top of the trunk, over the base; and
iv. the crown, trunk and pedestal forming at least one channel;
b. a plurality of lighting units residing within the at least one channel; wherein the channel is shaped and positioned to direct light from the plurality of lighting units toward product displayed on a merchandizer upon which the light strip is mounted.

2. The lighting structure of claim 1, the base comprising an elongate blade extending to either side of the trunk.

3. The lighting structure of claim 1, the plurality of lighting units being a plurality of LEDs.

4. The lighting structure of claim 1, further comprising two channels, one being a top channel and the other a bottom channel.

5. The lighting structure of claim 1, the at least one channel being shaped and sized to direct light behind the lighting structure.
